(19) United States
(12) Patent Application Publication
(10) Pub. No.: US 2024/0053571 A1
(43) Pub. Date: Feb. 15, 2024

(54) LENS MODULE AND CAMERA MODULE INCLUDING THE SAME

(71) Applicant: SAMSUNG ELECTRO-MECHANICS CO., LTD., Suwon-si (KR)

(72) Inventors: Seungyun PAEK, Suwon-si (KR); Jaekyung KIM, Suwon-si (KR)

(73) Assignee: SAMSUNG ELECTRO-MECHANICS CO., LTD., Suwon-si (KR)

(21) Appl. No.: 18/355,923

(22) Filed: Jul. 20, 2023

(30) Foreign Application Priority Data
Aug. 11, 2022 (KR) 10-2022-0100808
Apr. 4, 2023 (KR) 10-2023-0044069

(51) Int. Cl. G02B 7/02; G02B 7/08; G02B 27/64; G03B 17/12; H04N 23/68; H04N 23/55

(52) U.S. Cl. CPC G02B 7/021; G02B 7/08; G02B 27/644; G03B 17/12; H04N 23/687; H04N 23/55

(57) ABSTRACT

A lens module and a camera module including the same are provided. The lens module includes a lens barrel, a plurality of lens, and a lens holder. The plurality of lens includes at least one internal lens accommodated inside the lens barrel and an external lens fixed to a first end of the lens barrel. The lens holder includes a holder body that surrounds and supports the first end of the lens barrel and a lens support that extends from an inner circumferential surface of the holder body in a direction that intersects an optical axis direction and supports an edge of the external lens.

### CROSS-REFERENCE TO RELATED APPLICATIONS

This application claims priority under 35 USC § 119(a) to Korean Patent Application No. 10-2023-0044069, filed on Apr. 4, 2023 in the Korean Intellectual Property Office, and Korean Patent Application No. 10-2022-0100808, filed on Aug. 11, 2022 in the Korean Intellectual Property Office, the entire disclosures of which are incorporated herein by reference for all purposes.

### BACKGROUND

### 1. Field

The following description relates to a lens module and a camera module including the same.

### 2. Description of Related Art

Cameras have been applied to portable electronic devices such as smartphones. It is desirous that the cameras of portable electronic devices have a miniaturized form factor. As the various operations that are implemented in the cameras of portable electronic devices have increased, the components of lens modules and lens driving devices associated with the cameras have become increasingly complicated.

A typical lens module may include a plurality of lenses, a lens barrel that surrounds and fixes the plurality of lenses, and a lens holder that supports the lens barrel. However, since a size of the lens barrel is fixed, it may be difficult to add a lens for high functionality, and the addition of a lens module may make it difficult to secure reliability due to structural weakness of the lens module.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a lens module includes a lens barrel; a plurality of lenses comprising at least one internal lens accommodated inside the lens barrel and an external lens fixed to a first end of the lens barrel; and a lens holder comprising a holder body that surrounds and supports the first end of the lens barrel and a lens support that extends from an inner circumferential surface of the holder body in a direction that intersects an optical axis direction, wherein the lens support is configured to support an edge of the external lens.

The plurality of lenses may be configured such that light passing through the plurality of lenses is incident on an image sensor unit, and the external lens may be located closer to the image sensor unit than to the at least one internal lens.

The edge of the external lens may be bonded to the lens support and fixed to the lens support.

The holder body may include an inner circumferential surface that is parallel to the optical axis direction, and the lens support may have a ring shape that is orthogonal to the inner circumferential surface.

The lens module may further include a barrel support into which the first end of the lens barrel is fitted, and the barrel support may be located on the inner circumferential surface of the holder body.

The lens support may be located closer to the image sensor unit than the barrel support, and the lens support may protrude closer to the optical axis than the barrel support.

In a general aspect, a camera module includes a lens module including a lens barrel, a plurality of lenses fixed to the lens barrel, and a lens holder which surrounds and supports a first end of the lens barrel; and a lens driving device configured to move the lens module, wherein the plurality of lenses include at least one internal lens accommodated inside the lens barrel and an external lens fixed to the first end of the lens barrel, and wherein the lens holder includes a lens support that supports an edge of the external lens.

The camera module may include an image sensor unit configured to convert light incident through the plurality of lenses into an electrical signal, wherein the external lens is located closer to the image sensor unit than to the at least one internal lens.

The lens holder may include a holder body which has an inner circumferential surface that is parallel to an optical axis direction, the lens support may have a ring shape that extends in a direction intersecting the optical axis direction from the inner circumferential surface of the holder body, and the edge of the external lens is bonded to the lens support and fixed to the lens support.

The camera module may further include a barrel support into which the first end of the lens barrel is fitted, the barrel support is located on the inner circumferential surface of the holder body, and the lens support may protrude closer to the optical axis than the barrel support.

The camera module may further include a housing having an inner space; and a carrier disposed in the inner space of the housing and configured to accommodate the lens module, wherein the lens driving device includes an autofocus (AF) driving unit configured to drive the lens module and the carrier to move in an optical axis direction within the housing; and an optical image stabilization (OIS) driving unit configured to drive the lens module within the carrier to move in a first direction or a second direction perpendicular to the optical axis and perpendicular to each other.

Each of the AF driving unit and the OIS driving unit may be coupled to a rolling guide portion and a ball-shaped rolling portion to guide movement of the lens module and the carrier in the optical axis direction and guide movement of the lens module in the first direction or the second direction.

In a general aspect, an electronic device includes a lens module, including a lens barrel including a plurality of lenses; a lens holder configured to support the lens barrel; wherein the lens holder includes a flange that protrudes from an inner circumferential surface of the lens holder in a direction intersecting an optical axis, and a barrel support configured to support the lens barrel; wherein the flange is configured to support an edge of one of the plurality of lenses, and wherein a width of the flange is greater than a width of the barrel support.

The edge of the one of the plurality of lenses may be fixed to the flange by a bonding material.

Other features and aspects will be apparent from the following detailed description, the drawings, and the claims.

### BRIEF DESCRIPTION OF DRAWINGS

FIG. 1 illustrates a perspective view of an exterior of an example camera module, in accordance with one or more embodiments.

FIG. 2 illustrates an exploded perspective view of the example camera module shown in FIG. 1.

FIG. 3 illustrates an exploded perspective view of an example lens module of the example camera module shown in FIG. 2.

FIG. 4 illustrates a cross-sectional view of the example lens module shown in FIG. 3 in a coupled state.

FIG. 5 illustrates a cutaway perspective view of an example lens holder of the example lens module shown in FIG. 3.

FIG. 6 illustrates an exploded perspective view of an example lens module and an example housing of an example camera module, in accordance with one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure. For example, the sequences within and/or of operations described herein are merely examples, and are not limited to those set forth herein, but may be changed as will be apparent after an understanding of the disclosure, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning, e.g., the phrasing “in one example” has a same meaning as “in one embodiment”, and “one or more examples” has a same meaning as “in one or more embodiments.”

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Throughout the specification, when it is referred to “in plan view”, it means that a target element is viewed from above, and when it is referred to “in cross-sectional view”, it means that a target element taken vertically is viewed from the side.

One or more examples provide a lens module that improves the reliability of a product, for example, a camera, by improving the structural weakness of the lens module due to miniaturization and high operability of the camera, and a camera module including the same.

One or more example may prevent the external lens from moving inside the lens holder, and may prevent light from leaking through a gap between the external lens and the lens holder. Additionally, when the lens module is moved by the lens driving device, the lens module may be stably moved.

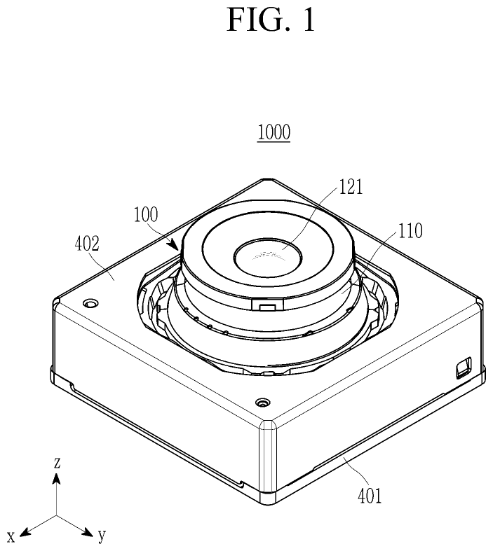

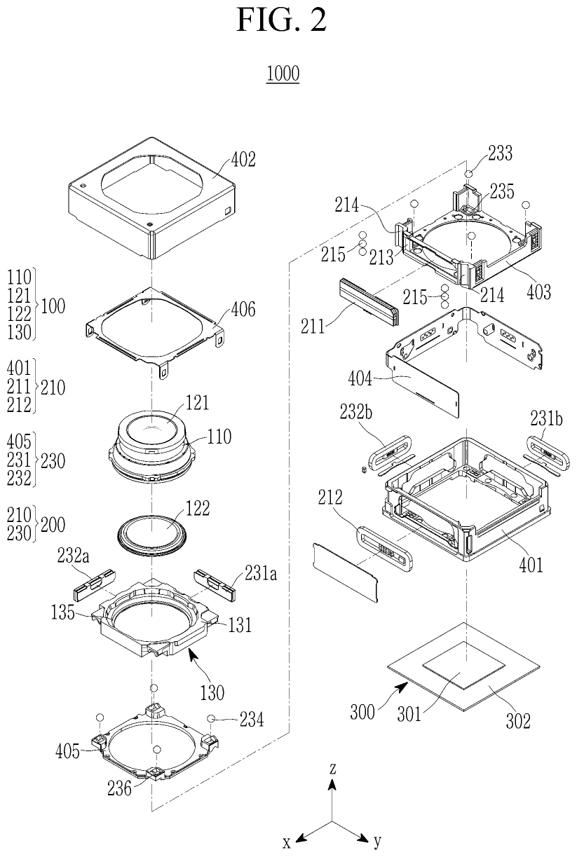

FIG. 1 illustrates a perspective view of an exterior of an example camera module, in accordance with one or more embodiments, and FIG. 2 illustrates an exploded perspective view of the example camera module shown in FIG. 1.

Referring to FIGS. 1 and 2, the camera module 1000, in accordance with one or more embodiments, may include a lens module 100, a lens driving device 200 that drives the lens module 100, an image sensor unit 300 that converts light incident through the lens module 100 into an electrical signal, a housing 401 that accommodates the lens module 100 and the lens driving device 200 in an inner space, and a cover 402 that covers the housing 401.

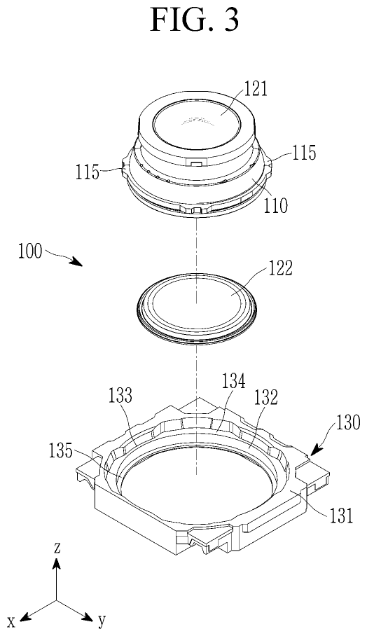

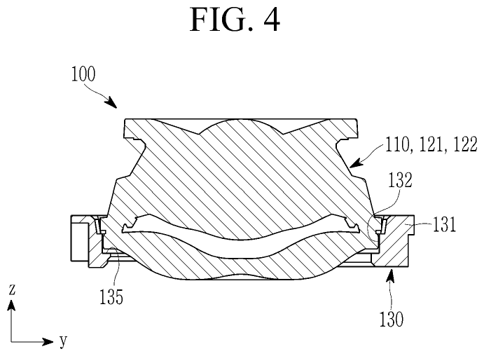

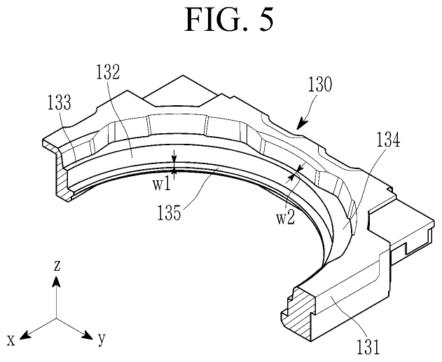

FIG. 3 is an exploded perspective view of an example lens module of the example camera module shown in FIG. 2, and FIG. 4 is a cross-sectional view of the example lens module shown in FIG. 3 in a coupled state. FIG. 5 is a cutaway perspective view of an example lens holder of the example lens module shown in FIG. 3.

Referring to FIGS. 3 to 5, the lens module 100 may include a lens barrel 110, a plurality of lenses 121 and 122 mounted on the lens barrel 110, and a lens holder 130 coupled to the lens barrel 110 to support the lens barrel 110. The lens barrel 110 may have a hollow cylindrical shape to accommodate at least one lens 121 therein, and the plurality of lenses 121 and 122 may be mounted on the lens barrel 110 along an optical axis.

The optical axis may be set as a central axis of the plurality of lenses 121 and 122 accommodated in the lens barrel 110, and an optical axis direction refers to a direction parallel to the central axis. In the figures, the optical axis is set as a z-axis, and an x-axis and a y-axis are set as directions perpendicular to the optical axis. In an example, the x-axis and the y-axis are perpendicular to each other, and an x-y plane formed by the x-axis and the y-axis is a plane perpendicular to the optical axis. In FIG. 4, for convenience, the lens barrel 110 and the plurality of lenses 121 and 122 are shown as a single integrated structure. However, this is only an example, and the lens barrel 110 and the plurality of lenses 121 and 122 may be separable from each other.

The plurality of lenses 121 and 122 include at least one internal lens 121 accommodated inside the lens barrel 110 and an external lens 122 fixed to one end of the lens barrel 110. One end of the lens barrel 110 to which the external lens 122 is fixed is an end (a lower end in the figure) facing the image sensor unit 300, and the external lens 122 may be located closer to the image sensor unit 300 than at least one internal lens 121.

In a non-limiting example, a diameter of the internal lens 121 may be the same as an inner diameter of the lens barrel 110, and a circumferential surface of the internal lens 121 may be fixed to an inner circumferential surface of the lens barrel 110. In an example, a diameter of the external lens 122 may be slightly smaller than an outer diameter of one end (a lower end) of the lens barrel 110, and the edge of one surface (an upper surface in the drawing) of the external lens 122 facing the lens barrel 110 may be fixed to one end (the lower end) of the lens barrel 110.

Unlike the internal lens 121, the external lens 122 may be located outside one side (a lower side) of the lens barrel 110, and the edge of the external lens 122 may overlap the lens barrel 110 in the optical axis direction (the z-axis direction).

Since the lens barrel 110 may have a fixed size and volume of inner space, adding an internal lens to improve an operation of the camera module may be technically limited. In the lens module 100 of the one or more examples, the external lens 122 may be fixed to one end (a lower end) of the lens barrel 110, and not to an inner side of the lens barrel 110, so that the number of lenses may be easily increased without deforming the lens barrel 110 and the internal lens 121.

One end (the lower end) of the lens barrel 110 and the external lens 122 may be accommodated inside the lens holder 130. The lens holder 130 may include a holder body 131 and a lens support or flange 135. In a non-limiting example, the holder body 131 may have a roughly rectangular shape, and may have a circular inner space to accommodate the lens barrel 110 and the external lens 122. That is, the lens holder 131 may have an approximately quadrangular outer surface and a circular inner circumferential surface 132.

In an example, the lens support 135 may be located on an inner circumferential surface 132 of the holder body 131, and may be in contact with the edge of the external lens 122 to support the external lens 122. The lens support 135 may extend from the inner circumferential surface 132 of the holder body 131 in a direction intersecting the optical axis direction. That is, the lens support 135 may be a plane perpendicular to the optical axis, and may have a ring shape with a predetermined width. An edge of the external lens 122 may be seated on the lens support 135 and may be stably supported by the lens support 135.

An edge of the external lens 122 may be fixed on the lens support 135 using a bonding unit or material, such as an adhesive. That is, the external lens 122 and the lens support 135 may be coupled to each other by bonding. In this example, the entirety of the lens barrel 110, the external lens 122, and the lens holder 130 may be structurally integrated, and reliability of the lens module 100 may be improved.

Specifically, the lens module 100 may prevent the external lens 122 from moving inside the lens holder 130, and may thus prevent light from leaking through a gap between the external lens 122 and the lens holder 130. Additionally, when the lens module 100 moves in the optical axis direction or in a direction perpendicular to the optical axis based on an operation of the lens driving device 200 described below, the lens module 100 may be stably moved.

In an example, a step-shaped barrel support 133 into which one end (the lower end) of the lens barrel 110 is fitted may be provided on the inner circumferential surface 132 of the lens holder 130. The barrel support 133 may be a plane perpendicular to the optical axis and may be located farther from the image sensor unit 300 than the lens support 135.

Additionally, the lens support 135 may protrude closer to the optical axis than the barrel support 133. That is, a width w1 of the lens support 135 (see FIG. 5) may be greater than a width w2 of the barrel support 133 (see FIG. 5). The lens support 135 may stably support the external lens 122 and the lens barrel 110 coupled to the external lens 122.

Additionally, a plurality of coupling protrusions 115 may be provided on an outer circumferential surface of the lens barrel 110 close to one end (the lower end) of the lens barrel 110, and a plurality of coupling recesses 134, into which a plurality of coupling protrusions 115 are fitted, may be provided on one surface (an upper surface) of the lens holder 130. The lens barrel 110 and the lens holder 130 may be mutually assembled by a protrusion-recess coupling structure.

In an example, the plurality of coupling protrusions 115 may be located at 90° intervals on the lens barrel 110, in a circumferential direction of the lens barrel 110, and the plurality of coupling recesses 134 may also be located to be spaced apart from each other at 90° intervals in the circumferential direction of the lens holder 130. The plurality of coupling recesses 134 may be connected to the barrel support 133 and may extend from the barrel support 133 toward the outside of the lens holder 130. In an example, the plurality of coupling recesses 134 may be located to respectively correspond to four corner portions of the lens holder 130.

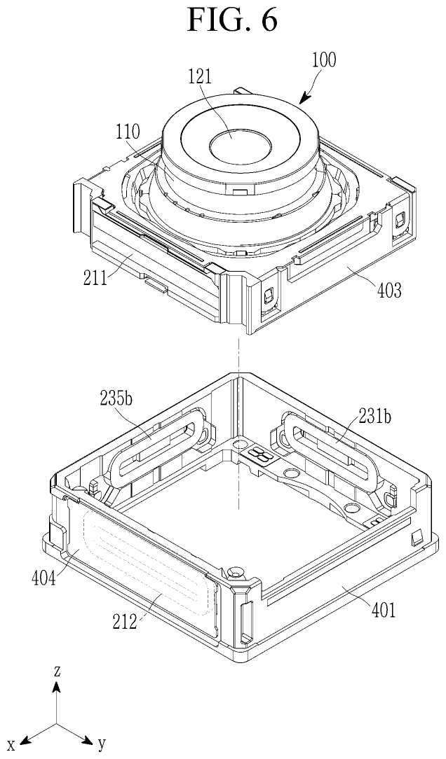

FIG. 6 illustrates an exploded perspective view of an example lens module and an example housing of an example camera module, in accordance with one or more embodiments.

Referring to FIGS. 2 and 6, the lens driving device 200 is a device that moves, or drives, a lens module. The lens driving device 200 may include an auto focus (AF) unit 210 that adjusts an image focus and an optical image stabilization (OIS) unit 230 that corrects hand shake or shake.

In an example, the lens driving device 200 may adjust the focus by moving the lens module 100 in the optical axis direction (the z-axis direction in the figure) using the AF unit 210 and may correct shake during an image capturing operation by moving the lens module 100 in a direction perpendicular to the optical axis (the x-axis or y-axis direction in the figure) using the OIS unit 230.

The AF unit 210 may include a carrier 403 that accommodates the lens module 100 and an AF drive portion that generates a driving force to move the lens module 100 and the carrier 403 in the optical axis direction. The AF drive portion may include an AF driving magnet 211 and an AF driving coil 212.

When power is applied to the AF driving coil 212, the carrier 403 may move in the optical axis direction due to electromagnetic influence between the AF driving magnet 211 and the AF driving coil 212. Since the lens module 100 is accommodated in the carrier 403, the focus may be adjusted while the lens module 100 moves in the optical axis direction based on the movement of the carrier 403.

In an example, the AF driving magnet 211 may be mounted on one surface of the carrier 403, that is, on an AF driving surface 213, and the AF driving coil 212 may be mounted on the housing 401 via a board 404. The AF driving magnet 211 is a movable member mounted on the AF driving surface 213 and moving in the optical axis direction together with the carrier 403, and the AF driving coil 212 is a fixed member fixed to the housing 401. However, the one or more examples are not limited thereto, and positions of the AF driving magnet 211 and the AF driving coil 212 may be interchanged.

A rolling guide portion 214 may be provided between the AF driving surface 213 and the housing 401 to reduce frictional contact between the carrier 403 and the housing 401 when the carrier 403 moves, and one or more ball-shaped rolling portions 215 may be disposed on the rolling guide portion 214. The rolling guide portion 214 may be configured as a guide recess parallel to the optical axis direction to limit the movement of the one or more rolling portions 215 in the optical axis direction.

The one or more rolling portions 215 may be disposed on both sides of the center of the AF driving surface 213 in a width direction. In an example, the one or more rolling portions 215 disposed on both sides may have the same number of balls or different numbers of balls.

The OIS unit 230 may be used to compensate for blurring of an image or shaking of a video due to factors, such as hand shaking of a user when capturing an image or capturing a video. The OIS unit 230 may compensate for the shaking by applying a relative displacement corresponding to the shaking to the lens module 100 when shaking occurs due to shaking of the user's hand during image capturing. In an example, the OIS unit 230 may correct shaking by moving the lens module 100 in a first direction (the x-axis direction) and a second direction (the y-axis direction) perpendicular to the optical axis direction.

The OIS unit 230 may include a support frame 405 that guides movement of the lens module 100 and an OIS drive portion that generates a driving force to move the support frame 405 in a direction perpendicular to the optical axis. The support frame 405 and the lens holder 130 may be accommodated in the carrier 403, may be aligned in the optical axis direction, and may be integrally coupled. The support frame 405 may guide movement of the lens module 100.

The OIS drive portion may include a first OIS drive portion 231 and a second OIS drive portion 232. The first OIS drive portion 231 may generate a driving force in the first direction (the x-axis direction) perpendicular to the optical axis, and the second OIS drive portion 232 may generate a driving force in a second direction (the y-axis direction) perpendicular to the first direction (the x-axis direction). The first and second OIS driving units 231 and 232 may include OIS driving magnets 231a and 232a and OIS driving coils 231b and 232b, respectively.

In the first OIS drive portion 231, when power is applied to the OIS driving coil 231b, the support frame 405 and the lens module 100 may move in the first direction (the x-axis direction) due to an electromagnetic influence between the OIS driving magnet 231a and the OIS driving coil 231b. In the second OIS drive portion 232, when power is applied to the OIS driving coil 232b, the support frame 405 and the lens module 100 may move in the second direction (the y-axis direction) due to an electromagnetic influence between the OIS driving magnet 232a and the OIS driving coil 232b.

In an example, the OIS driving magnets 231a and 232a may be respectively mounted on two sides of the lens holder 130 orthogonal to each other, and the OIS driving coils 231b and 232b may be mounted on the housing 401 via the board 404. The OIS driving magnets 231a and 232a are moving members that move in the first direction or the second direction together with the support frame 405 and the lens module 100, and the OIS driving coils 231b and 232b are fixed members fixed to the housing 401. However, the one or more examples are not limited thereto, and positions of the OIS driving magnets 231a and 232a and the OIS driving coils 231b and 232b may be interchanged.

In an example, the OIS unit 230 may include a plurality of rolling members. The plurality of rolling members may smooth the movement of the support frame 405 and the lens module 100 during an OIS driving process. Additionally, the plurality of rolling members may also maintain gaps between the carrier 403, the support frame 405, and the lens holder 130.

The plurality of rolling members may include a first rolling member 233 and a second rolling member 234. The first rolling member 233 may be involved in movement of the OIS unit 230 in the second direction (the y-axis direction), and the second rolling member 234 may be involved in the movement of the OIS unit 230 in the first direction (the x-axis direction). The first rolling member 233 may include a plurality of ball members located between the carrier 403 and the support frame 405, and the second rolling member 234 may include a plurality of ball members located between the support frame 405 and the lens holder 130.

A plurality of first guide grooves 235 that accommodate the first rolling member 233 may be located respectively at the corner regions of a surface of the carrier 405 facing the support frame 405 in the optical axis direction. In an example in which the first rolling member 233 is accommodated in the first guide recess 235, movement of the first rolling member 233 in the optical axis direction and the first direction (the x-axis direction) may be restricted, and the first rolling member 233 may move in the second direction (the y-axis direction).

A plurality of second guide grooves 236 that accommodate the second rolling member 234 may be located respectively at the corner regions of a surface of the support frame 405 facing the lens holder 130 in the optical axis direction. In an example in which the second rolling member 234 is accommodated in the second guide recess 236, movement of the second rolling member 234 in the optical axis direction and the second direction (y-axis direction) may be restricted, and the second rolling member 234 may move in the first direction (the x-axis direction).

The image sensor unit 300 is a device that converts light incident through the plurality of lenses 121 and 122 into an electrical signal. For example, the image sensor unit 300 may include an image sensor 301 and a circuit board 302 connected thereto, and may further include an infrared filter. The infrared filter may block light in an infrared region of light incident through the plurality of lenses 121 and 122.

The lens module 100 and the lens driving device 200 may be accommodated in the inner space of the housing 401. In an example, the housing 401 may have a box shape with upper and lower sides open, and the image sensor unit 300 may be located on a lower side of the housing 401. A stopper 406 may be disposed above the lens module 100, and the stopper 406 may be coupled to the carrier 403. The stopper 406 may prevent the support frame 405 and the lens module 100 from being separated from the inner space of the carrier 403.

The cover 402 may be coupled to the housing 401 to surround an outer surface of the housing 401, and may protect internal components of the camera module 1000. Additionally, the cover 402 may be formed of a metal shield can to shield electromagnetic waves. In this example, electromagnetic waves generated by the camera module 1000 may be blocked by the cover 402, and may not affect other electronic components in the portable electronic device.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A lens module, comprising:
a lens barrel;
a plurality of lenses comprising at least one internal lens accommodated inside the lens barrel and an external lens fixed to a first end of the lens barrel; and
a lens holder comprising a holder body that surrounds and supports the first end of the lens barrel and a lens support that extends from an inner circumferential surface of the holder body in a direction that intersects an optical axis direction,
wherein the lens support is configured to support an edge of the external lens.

2. The lens module of claim 1, wherein:
the plurality of lenses is configured such that light passing through the plurality of lenses is incident on an image sensor unit, and
the external lens is located closer to the image sensor unit than to the at least one internal lens.

3. The lens module of claim 2, wherein:
the edge of the external lens is bonded to the lens support and fixed to the lens support.

4. The lens module of claim 2, wherein:
the holder body comprises an inner circumferential surface that is parallel to the optical axis direction, and
the lens support has a ring shape that is orthogonal to the inner circumferential surface.

5. The lens module of claim 4, further comprising
a barrel support into which the first end of the lens barrel is fitted, and
the barrel support is located on the inner circumferential surface of the holder body.

6. The lens module of claim 5, wherein:
the lens support is located closer to the image sensor unit than the barrel support, and
the lens support protrudes closer to the optical axis than the barrel support.

7. An electronic device, comprising the lens module of claim 1.

8. A camera module, comprising:
a lens module comprising a lens barrel, a plurality of lenses fixed to the lens barrel, and a lens holder which surrounds and supports a first end of the lens barrel; and
a lens driving device configured to move the lens module,
wherein the plurality of lenses comprise at least one internal lens accommodated inside the lens barrel and an external lens fixed to the first end of the lens barrel, and
wherein the lens holder comprises a lens support that supports an edge of the external lens.

9. The camera module of claim 8, further comprising:
an image sensor unit configured to convert light incident through the plurality of lenses into an electrical signal,
wherein the external lens is located closer to the image sensor unit than to the at least one internal lens.

10. The camera module of claim 9, wherein:
the lens holder comprises a holder body which has an inner circumferential surface that is parallel to an optical axis direction,
the lens support has a ring shape that extends in a direction intersecting the optical axis direction from the inner circumferential surface of the holder body, and
the edge of the external lens is bonded to the lens support and fixed to the lens support.

11. The camera module of claim 10, further comprising
a barrel support into which the first end of the lens barrel is fitted, the barrel support is located on the inner circumferential surface of the holder body, and
the lens support protrudes closer to the optical axis than the barrel support.

12. The camera module of claim 8, further comprising:
a housing having an inner space; and
a carrier disposed in the inner space of the housing and configured to accommodate the lens module,
wherein the lens driving device comprises:
an autofocus (AF) driving unit configured to drive the lens module and the carrier to move in an optical axis direction within the housing; and
an optical image stabilization (OIS) driving unit configured to drive the lens module within the carrier to move in a first direction or a second direction perpendicular to the optical axis and perpendicular to each other.

13. The camera module of claim 12, wherein:
each of the AF driving unit and the OIS driving unit is coupled to a rolling guide portion and a ball-shaped rolling portion to guide movement of the lens module and the carrier in the optical axis direction and guide movement of the lens module in the first direction or the second direction.

14. An electronic device, comprising the camera module of claim 8.

15. An electronic device, comprising:
a lens module, comprising:
a lens barrel including a plurality of lenses;
a lens holder configured to support the lens barrel;
wherein the lens holder includes a flange that protrudes from an inner circumferential surface of the lens holder in a direction intersecting an optical axis, and a barrel support configured to support the lens barrel;
wherein the flange is configured to support an edge of one of the plurality of lenses, and
wherein a width of the flange is greater than a width of the barrel support.

16. The electronic device of claim 15, wherein the edge of the one of the plurality of lenses is fixed to the flange by a bonding material.
